(19) United States
(12) Patent Application Publication
(10) Pub. No.: US 2024/0132345 A1
(43) Pub. Date: Apr. 25, 2024

(54) PARTIAL OXIDATION SULFUR TECHNOLOGY (POST)

(71) Applicant: Saudi Arabian Oil Company, Dhahran (SA)

(72) Inventors: John O'Connell, Dhahran (SA); Amjad Shaarawi, Al Khobar (SA); Adrian Cesar Cavazos Sepulveda, Thuwal (SA)

(21) Appl. No.: 18/048,264

(22) Filed: Oct. 19, 2022

(51) Int. Cl. C01B 3/04; B01D 53/14; B01D 53/22; C01B 3/50; C01B 3/52; C01B 17/02; C01B 17/04

(52) U.S. Cl. CPC C01B 3/04; B01D 53/1425; B01D 53/1468; B01D 53/1475; B01D 53/229; C01B 3/501; C01B 3/506; C01B 3/52; C01B 17/0216; C01B 17/0404; C01B 17/0495; C01B 2203/0405; C01B 2203/0415; C01B 2203/046; C01B 2203/0485

(57) ABSTRACT

A method and a system to form hydrogen while removing sulfur from an acid gas stream are provided. An exemplary system includes a reaction furnace including a porous burner, an inlet for an oxygen stream into the porous burner, an inlet for the acid gas stream into the porous burner, and a plurality of inlets on the reaction furnace for injecting an inert coolant.

### TECHNICAL FIELD

The present disclosure is directed to generating hydrogen while removing sulfur from a waste gas stream.

### BACKGROUND

The production of natural gas often has associated hydrogen sulfide, which must be removed before the natural gas can be sold. Generally, this is performed through an absorption process that creates a sweetened gas stream and a waste gas stream. The waste gas stream is fed to a treatment and purification system to remove the hydrogen sulfide, and other sulfur compounds, in the form of sulfur. The sulfur can then be sold as a product.

As part of this procedure, a Claus plant is used. The Claus plant uses a reaction furnace to combust a portion of the hydrogen sulfide, forming sulfur dioxide. In the Claus reaction, the sulfur dioxide and the remaining hydrogen sulfide react to form water vapor and liquid sulfur. During the combustion process, a portion of the hydrogen sulfide dissociates, forming hydrogen and sulfur. A large proportion of the H₂ and S will then re-associate back to form H₂S, for example, as the combustion gases pass through a waste heat boiler that is downstream of the reaction furnace. Thus, the final H₂ concentration in an overhead stream from a conventional tail gas treatment process generally varies between 3 and 5%.

### SUMMARY

An embodiment described in examples herein provides a method to form hydrogen while removing sulfur from an acid gas stream. The method includes feeding the acid gas stream into a porous burner in a reaction furnace, feeding an oxidizer stream into the porous burner, dissociating hydrogen sulfide into hydrogen and sulfur in the reaction furnace and injecting an inert coolant into the reaction furnace to cool reaction products forming a product gas stream.

Another embodiment described in examples herein provides a system to form hydrogen while removing sulfur from an acid gas stream. The system includes a reaction furnace including a porous burner, an inlet for an oxygen stream into the porous burner, an inlet for the acid gas stream into the porous burner, and a plurality of inlets on the reaction furnace for injecting an inert coolant.

### BRIEF DESCRIPTION OF DRAWINGS

FIG. 1 is a block diagram of the Partial Oxidation Sulfur Technology (POST) system.

FIG. 2 is a cross sectional drawing of a reaction furnace that uses a porous burner and an inert coolant to increase dissociation of H₂ and S.

FIG. 3 is a cross sectional drawing of a sulfur condenser.

FIG. 4 is a simplified process flow diagram of a 3-stage Claus plant.

FIG. 5 is a simplified process flow diagram of a separation membrane.

FIG. 6 is a simplified process flow diagram of an adsorber.

FIG. 7 is a process flow diagram of a method for generating hydrogen while separating sulfur from a waste stream.

### DETAILED DESCRIPTION

Systems and methods are provided herein to increase the dissociation of H₂S to H₂ and S within a Sulfur Recovery Unit (SRU) setting, and enable the isolation of the H₂. The dissociation is accomplished through partial oxidation of H₂S in a direct-fired combustion chamber, using a “porous” burner to maximize H₂S dissociation. The porous burner can allow the dissociation to approach or achieve equilibrium values. To minimize the re-association of H₂ and S back to H₂S, an accelerated cooling process is used, for example, through the injection of an inert stream into a reactive furnace proximate to the porous burner. The inert stream may include, but is not limited to, N₂, argon, steam/H₂O, or liquid sulfur. In some embodiments, an expansion shock is used to rapidly drop the temperature of the stream.

After the reactive furnace, the SRU includes units for the conversion of the H₂S to elemental sulfur via the Claus process. The final tail gas stream from the SRU is then be processed in an additional unit that will separate and purify the H₂ from the bulk gas stream. The H₂ separation process may take the form of a membrane or an adsorption system. The high purity H₂ stream can then be used within the plant for fuel gas or process feed stream, or exported from the plant as a product stream. The process also allows for CO₂ sequestration.

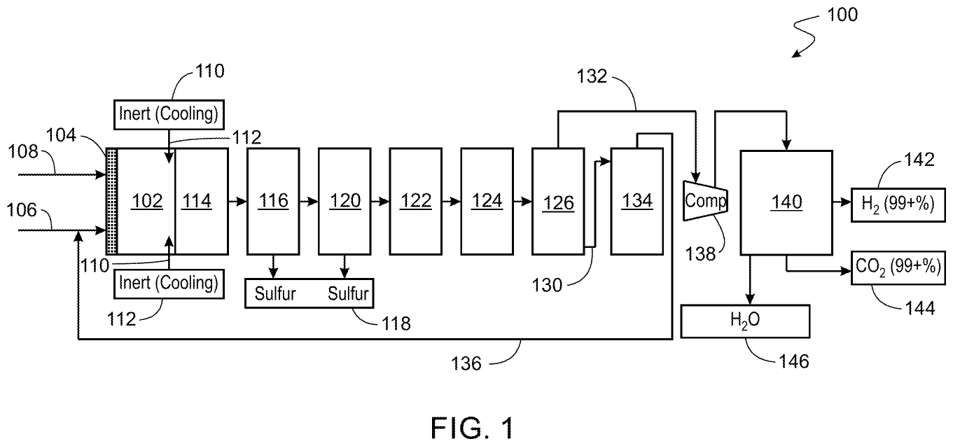

FIG. 1 is a block diagram of the Partial Oxidation Sulfur Technology (POST) system 100. In this embodiment, the post system 100 includes a reaction furnace 102 that has a porous burner 104. The porous burner 104 includes inlets for an acid gas stream 106 and an oxidizer stream 108.

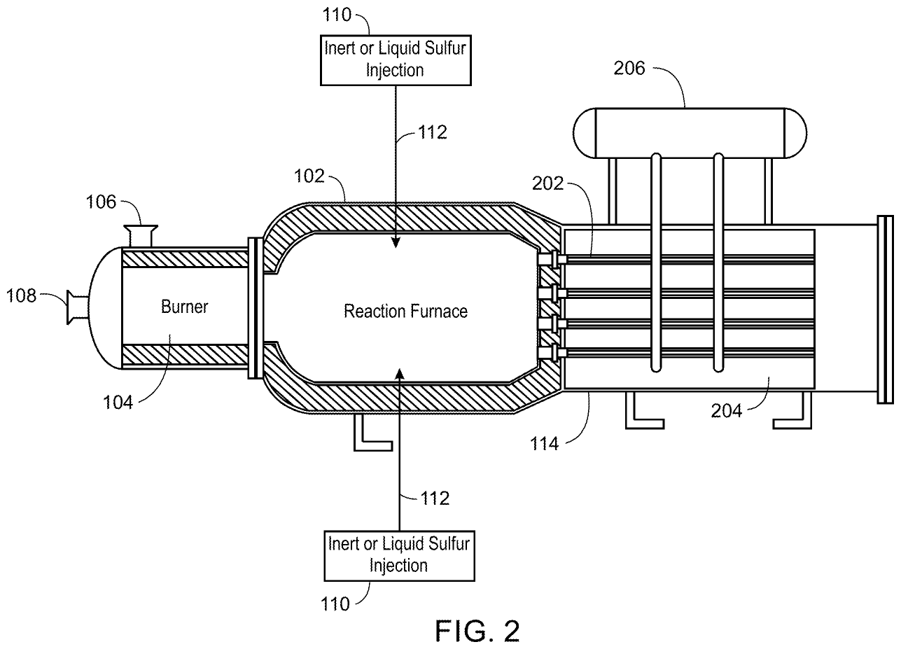

A waste heat reboiler 114 is placed immediately downstream of the reaction furnace 102. The waste heat reboiler 114 further cools the fluid from the reaction furnace 102, while generating steam for other processes. Further steam is generated by a sulfur condenser 116 that is disposed downstream of the waste heat reboiler 114 to condense gaseous sulfur to liquid sulfur. The boiler feed water for the waste heat reboiler 114 and the sulfur condenser 116 is the heat exchange medium that is converted to steam. The boiler feed water is provided by a utilities unit, for example, in a refinery. The steam generated may be used inside the sulfur recovery unit, exported to other process units, or both. The liquid sulfur 118 is collected in a sulfur pit. The porous burner 104, reaction furnace 102, and waste heat reboiler 114 are discussed further with respect to FIG. 2.

The vapor from the sulfur condenser 116 is then fed to a Claus plant 120. In various embodiments, the Claus plant 120 includes a 2-stage or 3-stage catalytic lineup for the reactions. A reduction-absorption tail gas treatment (TGT) process follows the Claus plant 120. This will allow for overall sulfur recovery efficiencies of 99.9+ percent.

In the TGT process, the tail gas from the Claus plant 120 is fed to a hydrogenation reactor 122. In the hydrogenation reactor, SO₂ and sulfur vapor are hydrogenated back to H₂S. Further, the reaction furnace 102 also produces CO as a side reaction. This CO is reacted with H₂O in a water-gas shift reaction in the hydrogenation reactor to form H₂ and CO₂, which increases the overall yield of H₂ in the process. Hydrogenation catalysts that can be used include a cobalt-molybdenum catalyst that is used for SRU service. The system is not limited to the cobalt-molybdenum catalyst, as in some embodiments, a cobalt-nickel catalyst, or a hydrotreating catalyst, is used.

The effluent from the hydrogenation reactor 122 is fed to a quench vessel 124. The quench vessel 124 rapidly cools the effluent, preventing further reactions from taking place. In the quench zones, or the quench vessel 124, an inert coolant is injected to reduce the temperature of the gas flowing through the quench vessel 124. In some embodiments, the quench vessel 124 is a water wash column.

The effluent from the quench vessel 124 is passed to an absorber 126, which uses a lean solvent to absorb H₂S from the effluent forming a rich solvent stream 130 and a low H₂S stream 132. The rich solvent stream 130 is passed to a stripper 134 that separates the H₂S from the solvent, reforming a lean solvent stream that is returned to the absorber 126, and a recycle H₂S stream 136 that is combined with the acid gas stream 106 that is fed to the porous burner 104.

The pressure of the low H₂S stream 132 is boosted by a compressor 138 before being fed to a separation system 140. As the POST system 100 is configured to have an injection of concentrated, or substantially pure, O₂ into the porous burner 104, the final overhead from the TGT primarily includes CO₂, H₂, and a saturated amount of H₂O. The separation system 140 generates a hydrogen stream 142, a CO₂ stream 144, and a liquid water stream 146. The hydrogen stream 142 and the CO₂ stream 144 are substantially pure. As used herein, substantially pure indicates that the gas stream has a concentration of higher than about 90 vol. %, 95 vol. %, 99 vol. %, or higher.

In various embodiments, a portion of the hydrogen stream 142 is used to provide the hydrogen to the hydrogenation reactor 122. The remainder of the hydrogen stream 142 is used as a product stream, for example, as a reacted in other processes, as a fuel, or exported to a pipeline for sale. The CO₂ stream 144 can be sold into a pipeline, for example, for enhanced oil recovery, or injected to a well for sequestration, among other uses.

In some embodiments, the liquid water stream 146 is removed from the other gases by condensation in a chiller, before separation of the remaining gases. The dewpoint of the remaining gases may affect the separation of H₂ and CO₂, for example, if an absorption unit is used. Accordingly, the chiller may be operated at a temperature of about 0.25° C. to about 5° C. to remove as much water as practical.

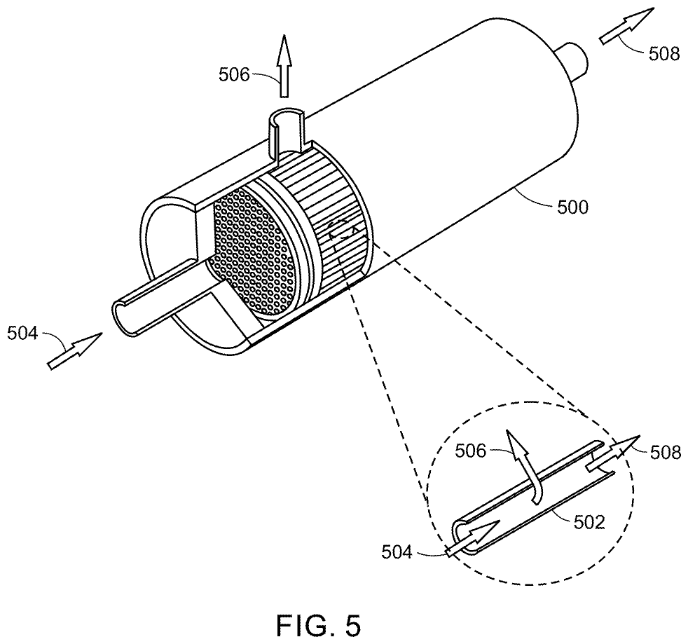

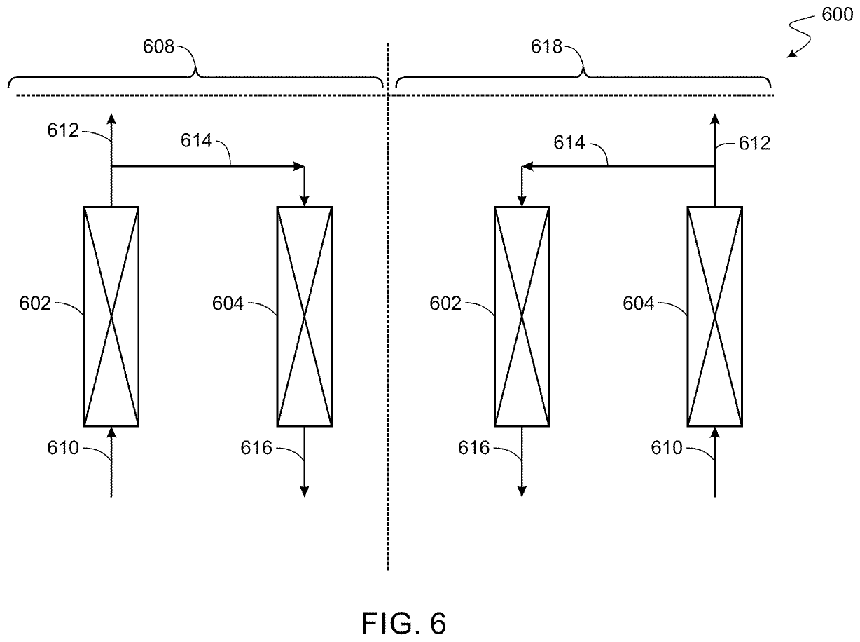

A separation system 140 is used to separate the H₂ from the CO₂. In various embodiments, the separation system 140 is a membrane separation system or an adsorption system, or a combination of both. These are discussed further with respect to FIGS. 5 and 6.

The POST system 100 maximizes the dissociation of H₂S into H₂ and sulfur in the thermal section of a Claus plant while simultaneously allowing for 99.9+% overall sulfur recovery efficiency via a 2-stage or 3-stage Claus plant with a Tail Gas Treatment (TGT) system, producing significant quantities of high purity H₂ and allowing for sequestration of a high purity CO₂ stream for decarbonization, e.g., through sequestration or sales.

FIG. 2 is a cross sectional drawing of a reaction furnace 102 that uses a porous burner 104 and an inert coolant 110 to increase dissociation of H₂ and S. Like numbered items are as described with respect to FIG. 1. In some embodiments, a “porous burner” in the reaction furnace 102, rather than a typical high-intensity burner, is used. A porous burner may allow for higher H₂S dissociation rates as it allows for access to super-adiabatic flame temperatures, i.e., higher than bulk gas adiabatic process temperatures. This is due to the physical configuration allowing for very short residence times that can be achieved compared to a typical burner. Further, the H₂S dissociation rates may be higher than equilibrium values due to intermediate polysulfides that are formed in the flame.

The final process stream from the TGT absorber overhead contains CO₂, H₂, a saturated amount of H₂O, and trace levels of H₂S. This stream will be compressed to allow for the implementation of a membrane and/or adsorption unit(s) to separate the H₂ from the process stream. The CO₂, also being of high purity, is ready for sequestration for carbon capture efforts.

The porosity of the porous burner 104 is adjusted from the inlets 106 and 108 to the pores that open into the reaction furnace 102. In the beginning of the porous zone, the porosity is typically low, in the range of 5-10 vol. %, in order to “trap” the flame and avoid a flashback. In the reaction zone, porosity is in the range of 80-90 vol. % to maximize reaction volume and minimize velocity of the reactants.

In various embodiments, the porous burner 104 is made from refractory carbides, such as tungsten carbide, silicon carbide, or titanium carbide, among others. The porous burner 104 can be made from other materials, such as refractory ceramics that include yttrium-stabilized zirconia or yttrium-doped barium zirconate, among others. Other materials that can be used to form the porous burner 104 include silicides, such as molybdenum silicide, or tungsten silicide, among others. Nitrides can also be used to form the porous burner 104, such as silicon nitride and mixtures thereof.

In various embodiments, the POST system 100 increases the dissociation of H₂S in the reaction furnace 102 by enriching the oxygen content of the oxidizer stream 108, for example, greater than about 90 vol. % purity, 95 vol. % purity, 99 vol. % purity, or higher. The use of the enriched oxygen increases the operating temperatures to be achieved, wherein higher temperatures result in higher levels of H₂S dissociation. For example, temperatures as high as 1000° C., 1300° C., or 1500° C. can be achieved based on the limit of the refractory material for the porous burner 104. In other embodiments, normal air is used as the oxidizer stream 108.

Generally, a catalyst is not needed for the reaction due to the very high reaction temperature. Further, the materials used to form the porous burner 104 itself also function as catalysts. However, refractory sulfides, including cerium sulfide, molybdenum sulfide, or barium sulfide, and mixtures thereof, can be included in the material of the porous burner 104 to increase the reaction rate.

The equilibrium predictions of the dissociation in the reaction furnace 102 are as high as 50 mol. % of the total inlet fed stream content of H₂S. This is performed by forcing the reaction furnace 102 to operate at as high a temperature as is practical, as well as implementing a quenching, or accelerated cooling, mechanism to minimize or eliminate re-association of H₂ and S to H₂S. The inert stream such as N₂ or H₂O will rapidly quench the RF temperature to 500-700° C. The quenching method is performed by the injection of an inert coolant 110, such as N₂, H₂O, or molten sulfur, through inlets 112 that are placed on the reaction furnace 102. For example, the inert coolant 110 is injected into the reaction furnace 102 through 3 to 10 inlets 112 can be placed in the same plane, radially around the shell of the reaction furnace 102. If liquid sulfur is used for the quenching, the injected sulfur will be immediately vaporized and will then be re-condensed and recovered in the first condenser. The liquid sulfur is sourced from the sulfur produced in the plant. Once the process stream is quenched, no further reaction of the H₂ occurs in the Claus plant.

Generally, the inlets 112 are placed in the reaction furnace 102 at a location that is associated with optimum residence time for the maximization of the H₂ yield, while maintaining the temperature long enough to destroy contaminants before quenching. In some embodiments, the inlets 112 may be placed proximate to the porous burner 104, to minimize the residence time. For example, the amount of contaminants may allow for a faster quench while in other embodiments higher contaminants may make a higher residence time more important. In some embodiments, having low amounts of contaminants, the optimum residence time in the reaction furnace 102 for maximum H₂ yield is between about 0.0 seconds to about 0.8 seconds. In other embodiments, the inlets 112 are placed closer to the waste heat reboiler to allow for a greater destruction of contaminants, for example, giving a residence time of about 1.5 seconds. The determination of the location of the inlets 112 is, thus, a trade-off between contaminants and hydrogen yield.

In the embodiment shown in FIG. 2, the reaction gases from the reaction furnace 102 flow through tubes 202 in the waste heat reboiler 114. The boiler feed water 204 surrounds the tubes 202, cooling the reaction gases. A steam separator 206 separates the steam leaving the top of the waste heat reboiler 114 through a riser, and re-injects the water into the bottom of the waste heat reboiler 114 through a downcomer. From the waste heat reboiler 114, the reaction gases flow into the sulfur condenser 116.

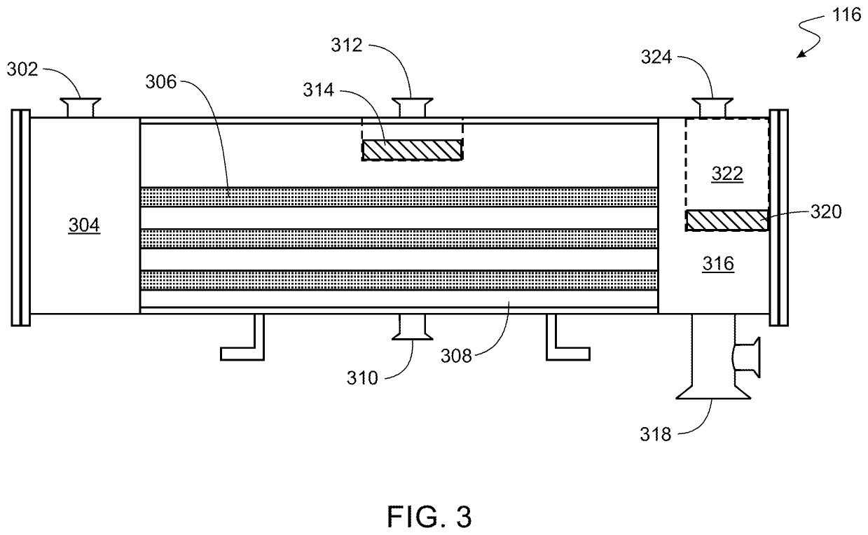

FIG. 3 is a cross sectional drawing of a sulfur condenser 116. Like numbered items are as described with respect to FIG. 1. The reaction gases flow into the sulfur condenser 116 through an inlet 302 that opens into a header 304. From the header, the reaction gases flow through tubes 306 that are immersed in water 308. The water 308, such as boiler feed water, is introduced into the sulfur condenser 116 by an inlet 310. As the heat from the process gases is transferred through the tubewalls of the tubes 106 to the boiler feedwater, water is vaporized into steam. The steam exits the sulfur condenser 116 through an outlet 312. A mesh pad 314 allows steam to exit through the outlet 312, but coalesces entrained water droplets, which drip back into the water 308 in the sulfur condenser 116.

The cooled reaction gases, and liquid sulfur condensed from the reaction gases, exit the tubes 306 into an exit header 316. The liquid sulfur drains from the exit header 316 through a liquid sulfur outlet 318. A mesh pad 320 blocks entrained sulfur liquid from being carried out of the sulfur condenser 116 with the cooled reaction gases, coalescing entrained sulfur droplets, which drop back into the exit header 316 and drain through the liquid sulfur outlet 318. The cooled reaction gases pass through the mesh pad 320 into a gas header 322, and exit through a gas outlet 324. From the sulfur condenser 116, the cooled reaction gases flow to a Claus plant for further recovery of sulfur.

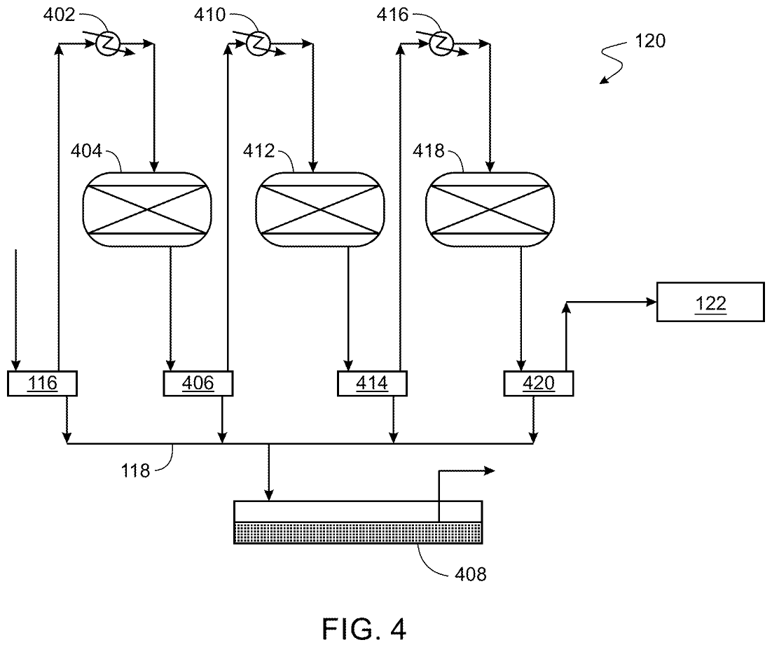

FIG. 4 is a simplified process flow diagram of a 3-stage Claus plant 120. In FIG. 4, the reaction gases that flow out of the sulfur condenser 116 pass through an indirect reheater 402 fed by 600 psig steam. After the reheater 402, the heated gases are flowed into a first catalytic converter 404. In the first catalytic converter 404, contact with a catalyst reacts SO₂(g) with H₂S(g) to form S(g) and H₂O(g), which is termed the Claus reaction. The catalyst may include activated alumina, titanium dioxide, and the like.

From the first catalytic converter 404, the reacted gases flow to a condenser 406. The condenser 406 cools the reacted gases and condenses sulfur 118, which is flowed, along with sulfur from the sulfur condenser, into a sulfur pit 408 for storage. The water vapor that is formed during the Claus reaction remains as a gas as the temperature of the condenser 406 is above the boiling point of water.

The cooled gases from the condenser 406 are reheated in second reheater 410 and flowed into a second catalytic converter 412, which converts further amounts of SO₂(g) and H₂S(g) into S(g) and H₂O(g). The reacted gases from the second catalytic converter 412 are flowed to a second condenser 414, which cools the reacted gases and condenses a further amount of sulfur 118, which is flowed into the sulfur pit 408.

In embodiments in which a third stage is used in the Claus plant, the cool gases from the second condenser 414 are reheated in a third reheater 416 and flowed into a third catalytic converter 418, which converts further amounts of SO₂(g) and H₂S(g) into S(g) and H₂O(g). The reacted gases from the third catalytic converter 418 are flowed to a third condenser 420, which cools the reacted gases and condenses a further amount of sulfur 118, which is flowed into the sulfur pit 408.

In some embodiments, the cooled gases, termed a Claus effluent stream, from the third condenser 420 is flowed directly to the hydrogenation reactor 122. After the hydrogenation reactor 122, the hydrogenated gases are flowed through the quench vessel 124 (FIG. 1) to remove bulk water, and any remaining H₂S is removed in the absorber 126, and recycled. As described with respect to FIG. 1, the pressure of the resulting low H₂S stream 132 from the absorber 126 is boosted in a compressor 138 prior to separating the water vapor, H₂, and CO₂. The water vapor can be removed by being condensed in a chiller and the remaining gases can be separated by either a separation membrane, as described with respect to FIG. 5, or an adsorption process, as described with respect to FIG. 6.

FIG. 5 is a schematic diagram of a separation membrane 500. In some embodiments, the separation membrane 500 is a canister that holds hollow fibers 502 that are made from a semi-permeable material. In various embodiments, the semi-permeable membrane is a polymer membrane, a ceramic membrane, a nanoporous metallic membrane and the like. Membranes that can be used are available from Evonik Industries AG, of Essen, Germany, among others. As the compressed feed gas 504 is passed through the hollow fibers 502, hydrogen diffuses through the wall of the hollow fibers 502 as a permeate 506, while larger molecules, such as CO₂, nitrogen, and others, passed through the hollow fibers 502 as a retentate 508. In some embodiments, multiple membrane units may be required to achieve required purity.

FIG. 6 is a simplified process flow diagram of an adsorber 600. In the embodiment of the adsorber 600 shown in FIG. 6, the adsorber 600 includes two columns 602 and 604, which each contain a packing material that can adsorb a gas. In various embodiments, the packing is a zeolite, calcium oxide, or other materials that can adsorb and desorb carbon dioxide. Generally, the hydrogen will pass through the packing without significant adsorption.

The adsorber 600 may be operated in a two-phase cycle. In a first phase 608, a first column 602 is operated in an adsorption mode, while the second column 604 is operated in a desorption mode. In the first phase 608, the compressed feed gas 610 is fed to the bottom of the first column 602 to adsorb and remove CO₂. The product gas 612, which comprises substantially pure H₂, exits the top of the first column 602. A portion of the product gas 612 is fed to the top of the second column 604 as a purge gas 614 that desorbs CO₂ from the packing of the second column 604, creating a CO₂ stream 616. During the desorption process, the second column 604 may be heated to drive the desorption of the CO₂.

The operation of the first phase 608 continues until CO₂ starts to break through the packing of the first column 602. At that point, the operation is reversed for a second phase 618. In the second phase 618, the first column 602 is operated in a desorption mode, while the second column 604 is operated in an adsorption mode.

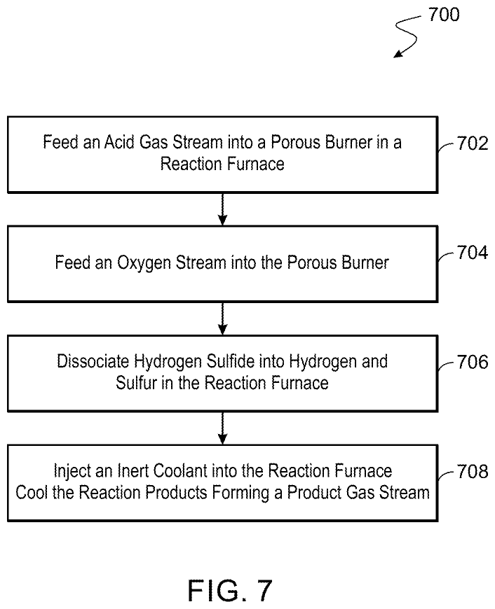

FIG. 7 is a process flow diagram of a method 700 for generating hydrogen while separating sulfur from a waste stream. The method begins at block 702 when an acid gas stream is fed to a porous burner in a reaction furnace. At block 704 an oxygen stream is fed to the porous burner, wherein the oxygen stream can include an oxygen concentration of 90 vol. %, or higher.

At block 706, a portion of the acid gas stream is combusted with the oxygen to form SO₂ and dissociate H₂S into H₂ and S. At block 708, an inert coolant is injected into the reaction furnace for accelerated cooling of the reaction products, at least partially preventing the re-association of H₂ and S back to H₂S.

As described herein, referring to FIG. 1 above, the POST system 100 converts H₂S to elemental sulfur using a modified reaction furnace 102. A porous burner 104 in the reaction furnace 102 is fed a high-purity oxygen stream, e.g., 90% or greater, to increase the combustion temperature and dissociation of H₂S, in the reaction furnace. The injection of an inert stream, such as N₂, H₂O (either steam or water), or liquid sulfur, into the reaction furnace 102 for accelerated cooling will limit the re-association of H₂ and sulfur, increasing the amount of hydrogen recovered in the process. The effluent from the reaction furnace 102 is processed in a Claus plant 120 and TGT process (122-126) to provide an overall recovery efficiency of 99.9+% of the sulfur, substantially decreasing SO₂ emissions targets over current SRU technologies.

After the removal of the sulfur in the TGT process, a separation system 140 separates H₂ from CO₂. The hydrogen formed in the process is provided as a hydrogen stream 142 for use as a fuel or a product. The POST system 100 also produces the CO₂ stream 144 for sequestration or sales.

### Embodiments

An embodiment described in examples herein provides a method to form hydrogen while removing sulfur from an acid gas stream. The method includes feeding the acid gas stream into a porous burner in a reaction furnace, feeding an oxidizer stream into the porous burner, dissociating hydrogen sulfide into hydrogen and sulfur in the reaction furnace and injecting an inert coolant into the reaction furnace to cool reaction products forming a product gas stream.

In an aspect, the oxidizer stream includes oxygen.

In an aspect, the oxidizer stream includes air or oxygen enriched air.

In an aspect, the method includes feeding the product gas stream to a Claus plant to remove at least a portion of sulfur compounds from the product gas stream as elemental sulfur, forming a Claus effluent stream. In an aspect, the method includes hydrogenating the Claus effluent stream to form a hydrogenated stream, quenching the hydrogenated stream to form a quenched stream, and feeding the quench stream to an absorber to remove hydrogen sulfide forming a hydrogen-enhanced stream. In an aspect, the method includes feeding the hydrogen-enhanced stream to a membrane separator to generate a hydrogen stream. In an aspect, the method includes passing the hydrogen-enhanced stream through a carbon dioxide scrubber to form a carbon dioxide stream. In an aspect, the method includes feeding a rich absorbent stream from the absorber to a regenerator to form a hydrogen sulfide recycle stream and a lean absorbent stream, and feeding the lean absorbent stream into the absorber. In an aspect, the method includes blending the hydrogen sulfide recycle stream into the acid gas stream prior to feeding the acid gas stream to the porous burner.

In an aspect, the method includes treating the product gas stream in a Claus plant to remove hydrogen sulfide, treating an effluent from the Claus plant in an absorber to remove residual hydrogen sulfide, and separating hydrogen from an effluent from the absorber.

In an aspect, the method includes generating steam in a waste heat boiler downstream of the reaction furnace.

In an aspect, the method includes condensing liquid sulfur in a condenser downstream of the waste heat reboiler.

Another embodiment described in examples herein provides a system to form hydrogen while removing sulfur from an acid gas stream. The system includes a reaction furnace including a porous burner, an inlet for an oxygen stream into the porous burner, an inlet for the acid gas stream into the porous burner, and a plurality of inlets on the reaction furnace for injecting an inert coolant.

In an aspect, the system includes a waste heat boiler downstream of the reaction furnace.

In an aspect, the system includes a Claus plant downstream of the reaction furnace. In an aspect, the system includes a hydrogenation reactor downstream of the Claus plant. In an aspect, the system includes a quench vessel downstream of the hydrogenation reactor. In an aspect, the system includes an absorber downstream of the Claus plant. In an aspect, the system includes a regenerator coupled to the absorber.

In an aspect, the system includes a compressor downstream of the adsorber. In an aspect, the system includes a hydrogen purification unit downstream of the compressor. In an aspect, the hydrogen purification unit includes a hydrogen separation membrane. In an aspect, the hydrogen purification unit includes an adsorption system.

Other implementations are also within the scope of the following claims.

What is claimed is:

1. A method to form hydrogen while removing sulfur from an acid gas stream, comprising:
feeding the acid gas stream into a porous burner in a reaction furnace;
feeding an oxidizer stream into the porous burner;
dissociating hydrogen sulfide into hydrogen and sulfur in the reaction furnace; and
injecting an inert coolant into the reaction furnace to cool reaction products forming a product gas stream.

2. The method of claim 1, wherein the oxidizer stream comprises oxygen.

3. The method of claim 1, wherein the oxidizer stream comprises air or oxygen enriched air.

4. The method of claim 1, comprising feeding the product gas stream to a Claus plant to remove at least a portion of sulfur compounds from the product gas stream as elemental sulfur, forming a Claus effluent stream.

5. The method of claim 4, comprising:
hydrogenating the Claus effluent stream to form a hydrogenated stream;
quenching the hydrogenated stream to form a quenched stream; and
feeding the quench stream to an absorber to remove hydrogen sulfide forming a hydrogen-enhanced stream.

6. The method of claim 5, comprising feeding the hydrogen enhanced stream to a membrane separator to generate a hydrogen stream.

7. The method of claim 5, comprising passing the hydrogen enhanced stream through a carbon dioxide scrubber to form a carbon dioxide stream.

8. The method of claim 5, comprising:
feeding a rich absorbent stream from the absorber to a regenerator to form a hydrogen sulfide recycle stream and a lean absorbent stream; and
feeding the lean absorbent stream into the absorber.

9. The method of claim 8, comprising blending the hydrogen sulfide recycle stream into the acid gas stream prior to feeding the acid gas stream to the porous burner.

10. The method of claim 1, comprising:
treating the product gas stream in a Claus plant to remove hydrogen sulfide;
treating an effluent from the Claus plant in an absorber to remove residual hydrogen sulfide; and
separating hydrogen from an effluent from the absorber.

11. The method of claim 1, comprising generating steam in a waste heat boiler downstream of the reaction furnace.

12. The method of claim 11, comprising condensing liquid sulfur in a condenser downstream of the waste heat reboiler.

13. A system to form hydrogen while removing sulfur from an acid gas stream, comprising:
a reaction furnace comprising a porous burner;
an inlet for an oxygen stream into the porous burner;
an inlet for the acid gas stream into the porous burner; and
a plurality of inlets on the reaction furnace for injecting an inert coolant.

14. The system of claim 13, comprising a waste heat boiler downstream of the reaction furnace.

15. The system of claim 13, comprising a Claus plant downstream of the reaction furnace.

16. The system of claim 15, comprising a hydrogenation reactor downstream of the Claus plant.

17. The system of claim 16, comprising a quench vessel downstream of the hydrogenation reactor.

18. The system of claim 15, comprising an absorber downstream of the Claus plant.

19. The system of claim 18, comprising a regenerator coupled to the absorber.

20. The system of claim 15, comprising a compressor downstream of the adsorber.

21. The system of claim 20, comprising a hydrogen purification unit downstream of the compressor.

22. The system of claim 21, wherein the hydrogen purification unit comprises a hydrogen separation membrane.

23. The system of claim 21, wherein the hydrogen purification unit comprises an adsorption system.
